(19) United States
(12) Patent Application Publication
(10) Pub. No.: US 2004/0096639 A1
(43) Pub. Date: May 20, 2004

(54) Uniform production methods for colored and non-colored polypropylene fibers

(76) Inventors: Brian G. Morin, Greer, SC (US); Martin E. Cowan, Moore, SC (US); Joseph R. Royer, Greenville, SC (US)

Correspondence Address: Milliken & Company, P. O. Box 1927, Spartanburg, SC, 29304, US

(21) Appl. No.: 10/295,441

(22) Filed: Nov. 16, 2002

(51) Int. Cl. B32B 5/12; D03D 15/00; D03D 25/00; B32B 27/02; B32B 27/04; B32B 27/12; D04H 1/00; D04H 3/00; D04H 5/00; D04H 13/00

(52) U.S. Cl. 428/299.7; 428/105; 442/327; 442/333; 442/353; 442/202

(57) ABSTRACT

Improvements in color management for polypropylene fiber production in terms of permitting similar if not identical processing conditions for both colored and uncolored fiber production are provided. Generally, either separate polypropylene fiber manufacturing lines or different processing conditions on the same manufacturing line are required for the production of colored and non-colored polypropylene fibers. This coloring is, for example, done by using pigments that may have a nucleation effect on the PP polymer which affects fiber properties. Such an inefficient situation exists due to the physical properties of drawn polypropylene fibers during manufacture, particularly the different properties exhibited between fibers including color and fibers that are colorless. Thus, it has been determined that specific additives can permit substantially identical fiber processing conditions (such as temperature and draw ratios, as examples) for colored and non-colored polypropylene fibers, providing greater efficiency to the manufacturer when switching between such fiber types is elected and/or necessary.

### FIELD OF THE INVENTION

This invention relates to improvements in color management for polypropylene fiber production in terms of permitting similar if not identical processing conditions for both colored and uncolored fiber production. Generally, either separate polypropylene fiber manufacturing lines or different processing conditions on the same manufacturing line are required for the production of colored and non-colored polypropylene fibers. This coloring is, for example, done by using pigments that may have a nucleation effect on the PP polymer which affects fiber properties. Such an inefficient situation exists due to the physical properties of drawn polypropylene fibers during manufacture, particularly the different properties exhibited between fibers including color and fibers that are colorless. Thus, it has been determined that specific additives can permit substantially identical fiber processing conditions (such as temperature and draw ratios, as examples) for colored and non-colored polypropylene fibers, providing greater efficiency to the manufacturer when switching between such fiber types or between different colors is elected and/or necessary.

Such fibers require the presence of certain compounds that quickly and effectively provide rigidity to the target polypropylene fiber on cooling. Generally, these compounds include any structure that nucleates polymer crystals within the target polypropylene after exposure to sufficient heat to melt the initial pelletized polymer and upon allowing such a melt to cool. The compounds must nucleate polymer crystals at a higher temperature than the target polypropylene without the nucleating agent during cooling. In such a manner, the “rigidifying” nucleator compounds provide nucleation sites for polypropylene crystal growth. After drawing the nucleated composition into fiber form, the fiber is then exposed to sufficient heat to grow the crystalline network, thus holding the fiber in a desired position. The preferred “rigidifying” compounds include dibenzylidene sorbitol based compounds, as well as less preferred compounds, such as certain sodium and lithium phosphate salts (such as sodium 2,2′-methylene-bis-(4,6-di-tert-butylphenyl)phosphate, otherwise known as NA-11 and similar product NA-21). Specific methods of manufacture of such fibers, as well as fabric articles made therefrom, are also encompassed within this invention.

### DISCUSSION OF THE PRIOR ART

There has been a continued desire to utilize polypropylene fibers in various different products, ranging from apparel to carpet backings (as well as carpet pile fabrics) to reinforcement fabrics, and so on. Polypropylene fibers exhibit excellent strength characteristics, highly desirable hand and feel, and do not easily degrade or erode when exposed to certain “destructive” chemicals. However, even with such impressive and beneficial properties and an abundance of polypropylene, which is relatively inexpensive to manufacture and readily available as a petroleum refinery byproduct, such fibers are not widely utilized. Some reasons for such a lack of use include high and generally non-uniform heat- and moisture-shrink characteristics exhibited by typical polypropylene fibers and inefficiency in manufacturing when switching between production of colored and non-colored polypropylene fibers on the same manufacturing line.

Such fibers are not heat stable and when exposed to standard temperatures (such as 150° C. and 130° C. temperatures), the shrinkage range from about 5% (in boiling water) to about 7-8% (for hot air exposure) to 12-13% (for higher temperature hot air). These extremely high and varied shrink rates thus render the utilization and process ability of highly desirable polypropylene fibers very low, particularly for end-uses that require heat stability (such as apparel, carpet pile, carpet backings, molded pieces, and the like). To date, there has been no simple solution to such a problem. Some ideas have included narrowing and controlling the molecular weight distribution of the polypropylene components themselves in each fiber or mechanically working the target fibers prior to and during heat-setting. Unfortunately, molecular weight control is extremely difficult to accomplish initially, and has only provided the above-listed shrink rates (which are still too high for widespread utilization within the fabric industry). Furthermore, the utilization of very high heat-setting temperatures during mechanical treatment has, in most instances, resulted in the loss of good hand and feel to the subject fibers. Another solution to this problem is preshrinking the fibers, which involves winding the fiber on a crushable paper package, allowing the fiber to sit in the oven and shrink for long times, (crushing the paper package), and then rewinding on a package acceptable for further processing. This process, while yielding an acceptable yarn, is expensive, making the resulting fiber uncompetitive as compared to polyester and nylon fibers. As a result, there has not been any teaching or disclosure within the pertinent prior art providing any heat- and/or moisture-shrink improvements in polypropylene fiber technology.

Furthermore, there exist substantial hurdles in manufacturing efficiency for polypropylene fibers, notably in terms of utilizing a single manufacturing line for the production of both colored using various pigments and noncolored polypropylene fibers. The processing conditions generally followed and essentially required for production of such varied fibers are quite dissimilar, particularly in terms of draw ratios between rolls and the draw temperature levels required for proper drawing of the fibers as well. Generally, colored fibers using various pigments will give different physical properties, related to those pigments, unless the equipment setup is changed to account for the effect of the pigment. Further processing and final applications require physical properties which are consistent and controlled, and thus the required changes in manufacturing setup needed to give consistent fiber properties with various pigments creates considerable undesirable complexity. Such complexity, and changes in manufacturing setup, require time and accumulate waste and are thus costly. It is this discrepancy that has been problematic from an efficiency standpoint for many polypropylene fiber manufacturers as the specific manufacturing lines must be reset to the requisite draw ratios or temperatures every time a change from colored to non-colored (or to differently colored) fiber products is effectuated. No modifications to compensate for such an inefficient discrepancy have been provided the polypropylene fiber manufacturing industry to date.

### DESCRIPTION OF THE INVENTION

It is thus an object of the invention to provide improved efficiencies in manufacturing procedures between colored and non-colored polypropylene fibers on the same manufacturing line. Further objects include improving the shrink rates for standard polypropylene fibers. A further object of the invention is to provide a class of additives that, in a range of concentrations, will permit such efficiency improvements as well as such low shrinkage rates. A further object of the invention is to provide a specific method for the production of nucleator-containing polypropylene fibers permitting the desired manufacturing processing condition similarities as well as the ultimate production of colored, pattern-colored, or non-colored low-shrink fabrics therewith. A further object of this invention is to provide a fiber containing a non-colored nucleating additive, and also containing a pigment or combination of pigments, such non-colored nucleating additive allowing the fiber to be manufactured under substantially the same manufacturing conditions, and give substantially the same fiber properties, regardless of the color of the pigment or combination of pigments. A further object of the invention is to provide a polypropylene fiber containing a soluble nucleating agent and a colored pigment.

Accordingly, this invention encompasses a colored polypropylene fiber, wherein said fiber is dimensionally stable and is made in accordance with substantially the same manufacturing procedures as a dimensionally stable non-colored polypropylene fiber having the same exact polypropylene composition but free from any coloring agent therein. Furthermore, this invention encompasses a method of producing such a colored fiber as above comprising the sequential steps of a) providing a polypropylene composition in pellet or liquid form comprising at least 200 ppm by weight of a nucleator compound and at least 200 ppm pf a coloring agent; b) melting and mixing said polypropylene composition of step “a” to form a substantially homogeneous molten plastic formulation; c) extruding said plastic formulation to form a fiber structure; optionally d) mechanically drawing said extruded fiber (optionally while exposing said fiber to a temperature of at most 105° C.); and, optionally, e) exposing said drawn fiber of step “d” to a subsequent heat-setting temperature of at least 110° C. Preferably, step “b” will be performed at a temperature sufficient to effectuate the melting of all polymer constituent (e.g., polypropylene), and possibly the remaining compounds, including the nucleating agent, as well (melting of the nucleating agent is not a requirement since some nucleating agents do not melt upon exposure to such high temperatures). Thus, temperatures within the range of from about 175 to about 300° C., as an example (preferably from about 190 to about 275°, and most preferably from about 200 to about 250° C., are proper for this purpose. The extrusion step (“c”) should be performed while exposing the polypropylene formulation to a temperature of from about 185 to about 300° C., preferably from about 190 to about 275° C., and most preferably from about 200 to about 250° C., basically sufficient to perform the extrusion of a liquefied polymer without permitting breaking of any of the fibers themselves during such an extrusion procedure. The drawing step may be performed at a temperature which is cooler than normal for a standard polypropylene (or other polymer) fiber drawing process. Thus, if a cold-drawing step is followed, such a temperature should be below about 105° C., more preferably below about 100° C., and most preferably below about 90° C. Of course, higher temperatures may be used if no such cold drawing step is followed. The final heat-setting temperature is necessary to “lock” the polypropylene crystalline structure in place after extruding and drawing. Such a heat-setting step generally lasts for a portion of a second, up to potentially a couple of minutes (i.e., from about 1/10^{th} of a second, preferably about ½ of a second, up to about 3 minutes, preferably greater than ½ of a second). The heat-setting temperature must be greater than the drawing temperature and must be at least 110° C., more preferably at least about 115°, and most preferably at least about 125° C. The term “mechanically drawing” is intended to encompass any number of procedures which basically involve placing an extensional force on fibers in order to elongate the polymer therein. Such a procedure may be accomplished with any number of apparatus, including, without limitation, godet rolls, nip rolls, steam cans, hot or cold gaseous jets (air or steam), and other like mechanical means.

The term “dimensionally stable” is intended to mean specifically a fiber that exhibits a minimum level of each of the following measurements: tensile strength, peak load, elongation at peak load, flexural modulus, tenacity, 1% secant modulus, 3% secant modulus, 5% secant modulus, and stress at 5% elongation. Thus, the term is intended to encompass a fiber that exhibits certain physical requirements in order to withstand incorporation within a fabric without breaking or otherwise disintegrating.

In another embodiment of the method of making such inventive fibers, step “c” noted above may be further separated into two distinct steps. A first during which the polymer is extruded as a sheet or tube, and a second during which the sheet or tube is slit into narrow fibers of less than 5000 deniers per filament (dpf).

All shrinkage values discussed as they pertain to the inventive fibers and methods of making thereof correspond to exposure times for each test (hot air and boiling water) of about 5 minutes. The heat-shrinkage at about 150° C. in hot air is, as noted above, at most 11% for the inventive fiber; preferably, this heat-shrinkage is at most 9%; more preferably at most 8%; and most preferably at most 7%. Also, the amount of nucleating agent present within the inventive fiber is at least 10 ppm; preferably this amount is at least 100 ppm; and most preferably is at least 1250 ppm. Any amount of such a nucleating agent should suffice to provide the desired shrinkage rates after heat-setting of the fiber itself; however, excessive amounts (e.g., above about 10,000 ppm and even as low as about 6,000 ppm) should be avoided, primarily due to costs, but also due to potential processing problems with greater amounts of additives present within the target fibers.

The term “polypropylene” is intended to encompass any polymeric composition comprising propylene monomers, either alone or in mixture or copolymer with other randomly selected and oriented polyolefins, dienes, or other monomers (such as ethylene, butylene, and the like). Such a term also encompasses any different configuration and arrangement of the constituent monomers (such as syndiotactic, isotactic, and the like). Thus, the term as applied to fibers is intended to encompass actual long strands, tapes, threads, and the like, of drawn polymer. The polypropylene may be of any standard melt flow (by testing); however, standard fiber grade polypropylene resins possess ranges of Melt Flow Indices between about 2 and 50. Contrary to standard plaques, containers, sheets, and the like (such as taught within U.S. Pat. No. 4,016,118 to Hamada et al., for example), fibers clearly differ in structure since they must exhibit a length that far exceeds its cross-sectional area (such, for example, its diameter for round fibers). Fibers are extruded and drawn; articles are blow-molded or injection molded, to name two alternative production methods. Also, the crystalline morphology of polypropylene within fibers is different than that of standard articles, plaques, sheets, and the like. For instance, the dpf of such polypropylene fibers is at most about 5000; whereas the dpf of these other articles is much greater. Polypropylene articles generally exhibit spherulitic crystals while fibers exhibit elongated, extended crystal structures. Thus, there is a great difference in structure between fibers and polypropylene articles such that any predictions made for spherulitic particles (crystals) of nucleated polypropylene do not provide any basis for determining the effectiveness of such nucleators as additives within polypropylene fibers.

The terms “nucleators”, “nucleator compound(s)”, “nucleating agent”, and “nucleating agents” are intended to generally encompass, singularly or in combination, any additive to polypropylene that produces nucleation sites for polypropylene crystals from transition from its molten state to a solid, cooled structure. Hence, since the polypropylene composition (including nucleator compounds) must be molten to eventually extrude the fiber itself, the nucleator compound will provide such nucleation sites upon cooling of the polypropylene from its molten state. The only way in which such compounds provide the necessary nucleation sites is if such sites form prior to polypropylene recrystallization itself. Thus, any compound that exhibits such a beneficial effect and property is included within this definition. Such nucleator compounds more specifically include dibenzylidene sorbitol types, including, without limitation, dibenzylidene sorbitol (DBS), monomethyldibenzylidene sorbitol, such as 1,3:2,4-bis(p-methylbenzylidene) sorbitol (pMDBS), dimethyl dibenzylidene sorbitol, such as 1,3:2,4-bis(3,4-dimethylbenzylidene) sorbitol (3,4-DMDBS); other compounds of this type include, again, without limitation, sodium benzoate, NA-11, NA-21 and the like. Sodium benzoate, while partially effective, is not preferred because it exhibits critical flaws such as the off gassing of benzoic acid, which tends to deteriorate equipment and also cause debris in the manufacturing process. The concentration of such nucleating agents (in total) within the target polypropylene fiber is at least 200 ppm, preferably at least 1250 ppm. Thus, from about 200 to about 10,000 ppm, preferably from about 400 ppm to about 6000 ppm, more preferably from about 1250 ppm to about 5000 ppm, still more preferably from about 1500 ppm to about 4000 ppm, and most preferably from about 1750 to about 3000 ppm. Furthermore, fibers may be produced by the extrusion and drawing of a single strand of polypropylene as described above, or also by extrusion of a sheet, then cutting the sheet into fibers, then following the steps as described above to draw, heat-set, and collect the resultant fibers. In addition, other methods to make fibers, such as fibrillation, and the like, are envisioned for the same purpose.

Also, without being limited by any specific scientific theory, it appears that the nucleators which perform the best are those which exhibit relatively high solubility within the propylene itself. Thus, compounds which are readily soluble, such as 1,3:2,4-bis(p-methylbenzylidene) sorbitol provides the most consistent physical properties for the desired pigmented polypropylene fibers. The DBS derivative compounds are considered the best nucleators within this invention due to the low crystalline sizes produced by such compounds. Other nucleators, such as NA-11, also provide good characteristics to the target polypropylene fiber; however, apparently due to poor dispersion of NA-11 in polypropylene and the large and varied crystal sizes of NA-11 within the fiber itself, the physical properties and or processing differences are noticeably more varied than for the highly soluble, low crystal-size polypropylene produced by well-dispersed MDBS.

One manner of testing for the presence of a nucleating agent within the target fibers is preferably through differential scanning calorimetry to determine the peak crystallization temperature exhibited by the resultant polypropylene. The fiber is melted and placed between two plates under high temperature and pressure to form a sheet of sample plastic. A sample of this plastic is then melted and subjected to a differential scanning calorimetry analytical procedure in accordance with modified ASTM Test Method D3417-99 at a cooling rate of 20° C./minute. A sufficiently high peak crystallization temperature (above about 115° C., more preferably above about 116° C., and most preferably above about 116.5° C.), well above that exhibited by the unnucleated polypropylene itself, shall indicate the presence of a nucleating agent since attaining such a high peak crystallization without a nucleating agent is not generally possible.

It has been determined that the nucleator compounds that exhibit good solubility in the target molten polypropylene resins (and thus are liquid in nature during that stage in the fiber-production process) provide more effective characteristics. Thus, low substituted DBS compounds (including DBS, p-MDBS) appear to provide fewer manufacturing issues as well as lower shrink properties within the finished polypropylene fibers themselves. Although p-MDBS is preferred, however, any of the above-mentioned nucleators may be utilized within these inventive colored fibers as long as the amounts present accord the same temperature and draw ratios for like nucleated non-colored fibers to impart substantially similar physical properties exhibited by such non-colored fiber thereto such inventive colored fibers ultimately. Mixtures of such nucleators may also be used during processing in order to provide such low-shrink properties as well as possible organoleptic improvements, facilitation of processing, or cost.

In addition to those compounds noted above, sodium benzoate and NA-11 are well known as nucleating agents for standard polypropylene compositions (such as the aforementioned plaques, containers, films, sheets, and the like) and exhibit excellent recrystallization temperatures and very quick injection molding cycle times for those purposes. The dibenzylidene sorbitol types exhibit the same types of properties as well as excellent clarity within such standard polypropylene forms (plaques, sheets, etc.). For the purposes of this invention, it has been found that the dibenzylidene sorbitol types are preferred as nucleator compounds within the target polypropylene fibers

The closest prior art references teach the addition of nucleator compounds to general polypropylene compositions (such as in U.S. Pat. No. 4,016,118, referenced above). However, some teachings include the utilization of certain DBS compounds within limited portions of fibers in a multicomponent polypropylene textile structure. For example, U.S. Pat. No. 5,798,167 to Connor et al. and U.S. Pat. No. 5,811,045 to Pike, both teach the addition of DBS compounds to polypropylene in fiber form; however, there are vital differences between those disclosures and the present invention. For example, both patents require the aforementioned multicomponent structures of fibers. Thus, even with DBS compounds in some polypropylene fiber components within each fiber type, the shrink rate for each is dominated by the other polypropylene fiber components which do not have the benefit of the nucleating agent. Also, there are no lamellae that give a long period (as measured by small-angle X-ray scattering) thicker than 20 nm formed within the polypropylene fibers due to the lack of a post-heatsetting step being performed. Again, these thick lamellae provide the desired inventive higher heat-shrink fiber. Also of importance is the fact that, for instance, Connor et al. require a nonwoven polypropylene fabric laminate containing a DBS additive situated around a polypropylene internal fabric layer which contained no-nucleating agent additive. The internal layer, being polypropylene without the aid of a nucleating agent additive, dictates the shrink rate for this structure. Furthermore, the patentees do not expose their yarns and fibers to heat-setting procedures in order to permanently configure the crystalline fiber structures of the yarns themselves as low-shrink is not their objective. Nor is there any discussion of the improvements in manufacturing efficiency provided such inventive colored fibers with such additives present therein, as has now been discovered.

In addition, Spruiell, et al, Journal of Applied Polymer Science, Vol. 62, pp. 1965-75 (1996), reveal using a nucleating agent, MDBS, at 0.1%, to increase the nucleation rate during spinning. However, after crystallizing and drawing the fiber, Spruiell et al. do not expose the nucleated fiber to any heat, which is necessary to impart the very best shrinkage properties, therefore the shrinkage of their fibers was similar to conventional polypropylene fibers without a nucleating agent additive. In none of the above mentioned prior art was any experimentation or discovery of the interaction of nucleating agents and pigments during the manufacture of polypropylene yarn. It is principally within this interaction that the beneficial effect of the inventive fibers is found.

Coloring agents, herein defined as any of at least one colorant, pigment, dye, and/or dyestuff, may impart not only the required colorations within the target fibers, but also may impart some degree of nucleation therein as well. Surprisingly, however, although a potential nucleator, being a coloring agent, is present within the target fibers, the presence of specific nucleators provides the desired results in terms of substantial similarities in processing conditions to produce similar physical characteristics as non-colored polypropylene fibers of the same polypropylene composition. Without intending to be limited to any specific scientific theory, it is believed that the nucleators required within the inventive colored fibers dominate crystal formation to such a degree within either colored or non-colored fibers that the fibers ultimately appear to the substantially the same from a physical standpoint, no matter what other nucleating agents may be present therein.

Other additives may also be present within the target fibers as well, including antistatic agents, brightening compounds, clarifying agents, antioxidants, antimicrobials (preferably silver-based ion-exchange compounds, such as ALPHASAN® antimicrobials available from Milliken & Company), UV stabilizers, fillers, and the like. Furthermore, any fabrics made from such inventive fibers may be, without limitation, woven, knit, non-woven, in-laid scrim, any combination thereof, and the like. Additionally, such fabrics may include fibers other than the inventive polypropylene fibers, including, without limitation, natural fibers, such as cotton, wool, abaca, hemp, ramie, and the like; synthetic fibers, such as polyesters, polyamides, polyaramids, other polyolefins (including non-low-shrink polypropylene), polylactic acids, and the like; inorganic fibers such as glass, boron-containing fibers, and the like; and any blends thereof.

### BRIEF DESCRIPTION OF THE DRAWINGS

The accompanying drawings, which are incorporated in and constitute a part of this specification, illustrate a potentially preferred embodiment of producing the inventive low-shrink polypropylene fibers and together with the description serve to explain the principles of the invention wherein:

FIG. 1 is a schematic of the potentially preferred method of producing the target colored polypropylene fibers.

### DETAILED DESCRIPTION OF THE DRAWING AND OF THE PREFERRED EMBODIMENT

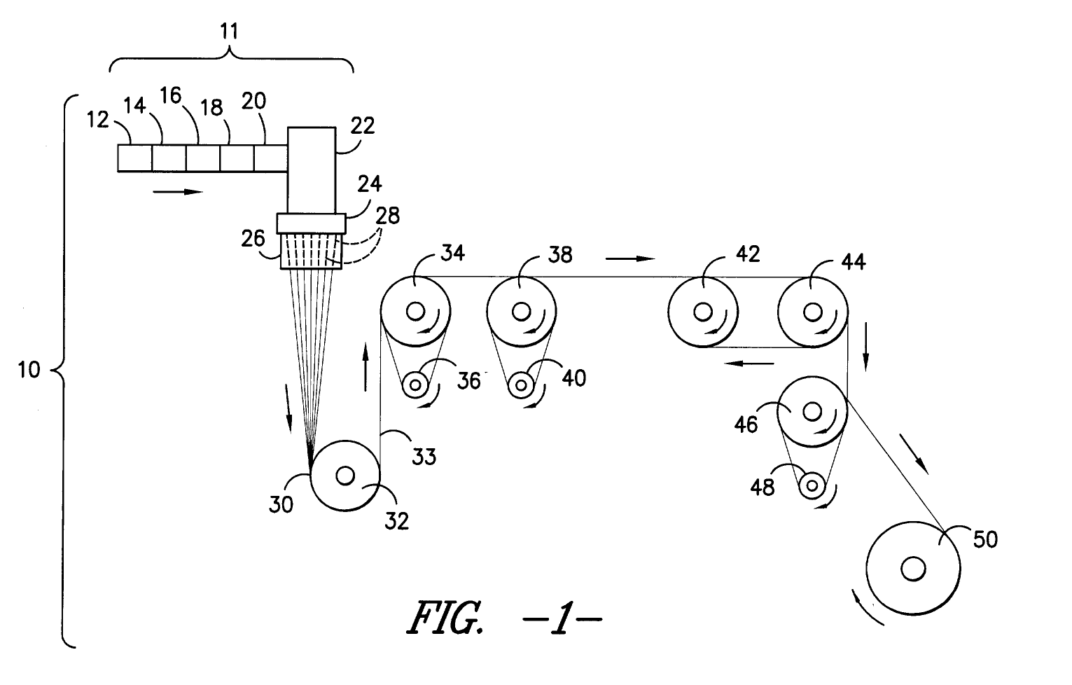

FIG. 1 depicts the non-limiting preferred procedure followed in producing the inventive low-shrink polypropylene fibers. The entire fiber production assembly 10 comprises an extruder 11 comprising four different zones 12, 14, 16, 18 through which the polymer (not illustrated) passes at different, increasing temperatures. The molten polymer is mixed with the nucleator compound (also molten) within a mixer zone 20. Basically, the polymer (not illustrated) is introduced within the fiber production assembly 10, in particular within the extruder 11. The temperatures, as noted above, of the individual extruder zones 12, 14, 16, 18 and the mixing zone 20 are as follows: first extruder zone 12 at 205° C., second extruder zone 14 at 215° C., third extruder zone 16 at 225° C., fourth extruder zone 18 at 235° C., and mixing zone 20 at 245° C. The molten polymer (not illustrated) then moves into a spin head area 22 set at a temperature of 250° C. which is then moved into the spinneret 24 (also set at a temperature of 250° C.) for strand extrusion. The fibrous strands 28 then pass through a heated shroud 26 having an exposure temperature of 180° C. The speed at which the polymer strands (not illustrated) pass through the extruder 11, spin pack 22, and spinneret 24 is relatively slow until the fibrous strands 28 are pulled through by the draw rolls 32, 34, 38. The fibrous strands 28 extend in length due to a greater pulling speed in excess of the initial extrusion speed within the extruder 11. The fibrous strands 28 are thus collected after such extension by a take-up roll 32 (set at a speed of 370 meters per minute) into a larger bundle 30 which is drawn by the aforementioned draw rolls 34, 38 into a single yarn 33. The draw rolls are heated to a very low level as follows: first draw roll 34 68° C. and second draw roll 38 88° C., as compared with the remaining areas of high temperature exposure as well as comparative fiber drawing processes. The first draw roll 34 rotates at a speed of about 377 meters per minute and is able to hold fifteen wraps of the polypropylene fiber 33 through the utilization of a casting angle between the draw roll 34 and the idle roll 36. The second draw roll 38 rotates at a higher speed of about 785 meters per minute and holds eight wraps of fiber 33, and thus requires its own idle roll 40. After drawing by these cold temperature rolls 34, 38, the fiber is then heat-set by a combination of two different heat-set rolls 42, 44 configured in a return scheme such that eighteen wraps of fiber 33 are permitted to reside on the rolls 42, 44 at any one time. The time of such heat-setting is very low due to a low amount of time in contact with either of the actual rolls 42, 44, so a total time of about 0.5 seconds is standard. The temperatures of such rolls 42, 44 are varied below to determine the best overall temperature selection for such a purpose. The speed of the combination of rolls 42, 44 is about 1290 meters per minute. The fiber 33 then moves to a relax roll 46 holding up to eight wraps of fiber 33 and thus also having its own feed roll 48. The speed of the relax roll 46 is lower than the heat-set roll (1280 meters per minute) in order to release some tension on the heat-set fiber 33. From there, the fiber 33 moves to a winder 50 and is placed on a spool (not illustrated).

### Inventive Fiber and Yarn Production

The following non-limiting examples are indicative of the preferred embodiment of this invention:

Yarn Production

Yarn was made by compounding Amoco 7550 fiber grade polypropylene resin (melt flow of 18) with 2500 ppm of a nucleator additive in half of the samples, a dyestuff or pigment, and a standard polymer stabilization package consisting of 500 ppm of Irganox® 1010, 1000 ppm of Irgafos® 168 (both antioxidants available from Ciba), and 800 ppm of calcium stearate. The base mixture was compounded in a twin screw extruder (at 220° C. in all zones) and made into pellets. The nucleating additive was selected from the group of two polypropylene clarifiers commercially available from Milliken & Company, Millad® 3940 (p-MDBS) and Millad® 3988 (3,4-DMDBS).

The pellets were then fed into the extruder on an Alex James & Associates fiber extrusion line as noted above in FIG. 1. Yarn was spun with the extrusion line conditions shown in Table 1 using a 68 hole spinneret, giving a yarn of nominally 150 denier. Heatset rolls 42, 44, were set at 130 C.

The yarns were tested for tensile strength, modulus strength, fiber tenacity, stress at 5% elongation, 1%, 3%, and 5% secant modulus strength, peak load, and elongation at peak load, to determine if the produced fibers were, in fact, dimensionally stable.

The shrink measurements are listed below the tested nucleators and coloring agents for each yarn sample. The yarn samples were as follows (with the nucleators all added at 2750 ppm):

POLYPROPYLENE YARN COMPOSITION TABLE
Yarn Samples with Specific Nucleators Added

| Yarn Sample | Nucleator Added | Coloring Agent |
|---|---|---|
| A | None | None |
| B | p-MDBS | None |
| C | None | 250 ppm 86600 Blue 25% GSP |
| D | p-MDBS | 250 ppm 86600 Blue 25% GSP |
| E | None | 500 ppm 86600 Blue 25% GSP |
| F | p-MDBS | 500 ppm 86600 Blue 25% GSP |
| G | None | 1000 ppm 86600 Blue 25% GSP |
| H | p-MDBS | 1000 ppm 86600 Blue 25% GSP |
| I | None | 2000 ppm 86600 Blue 25% GSP |
| J | p-MDBS | 2000 ppm 86600 Blue 25% GSP |
| K | None | 250 ppm Lawn Green 12% |
| L | p-MDBS | 250 ppm Lawn Green 12% |
| M | None | 1000 ppm Lawn Green 12% |
| N | p-MDBS | 1000 ppm Lawn Green 12% |
| O | None | 2000 ppm Lawn Green 12% |
| P | p-MDBS | 2000 ppm Lawn Green 12% |
| Q | None | 250 ppm Fade Red HUV |
| R | p-MDBS | 250 ppm Fade Red HUV |
| S | None | 500 ppm Fade Red HUV |
| T | p-MDBS | 500 ppm Fade Red HUV |
| U | None | 750 ppm Fade Red HUV |
| V | p-MDBS | 750 ppm Fade Red HUV |
| W | None | 250 ppm Yellow HG 25% |
| X | p-MDBS | 250 ppm Yellow HG 25% |
| Y | None | 1000 ppm Yellow HG 25% |
| Z | p-MDBS | 1000 ppm Yellow HG 25% |

### Fiber and Yarn Physical Analyses

These sample yarns, produced at 125° C. draw temperature and at a draw ratio of 3.4, were then tested for the above-noted fiber physical measurements and shrink characteristics. The results are tabulated below:

EXPERIMENTAL TABLE 1
Experimental Physical Measurements for Sample Yarns

| | | | % Elong. | Fib. |
|---|---|---|---|---|
| Sample | Denier | Peak Load (gf) | At Peak Load | Tenac. (gf/den) |
| A | 154.5 | 692.5 | 48.76 | 4.482 |
| B | 156.1 | 618.3 | 86.52 | 3.961 |
| C | 153.2 | 590.4 | 81.17 | 3.854 |
| D | 152 | 564.2 | 63.22 | 3.712 |
| E | 153.7 | 577.1 | 84.71 | 3.755 |
| F | 152.2 | 560.3 | 34.57 | 3.681 |
| G | 152 | 562.8 | 91.78 | 3.703 |
| H | 150.8 | 317.4 | 57.34 | 4.094 |
| I | 153.8 | 545.9 | 77.21 | 3.549 |
| J | 153.5 | 591.3 | 75.97 | 3.594 |
| K | 154.1 | 578.8 | 40.79 | 3.756 |
| L | 156.1 | 633.0 | 64.09 | 4.055 |
| M | 152.3 | 585.9 | 48.79 | 3.847 |
| N | 151.7 | 600.2 | 65.23 | 3.957 |
| O | 154.8 | 580.8 | 64.02 | 3.752 |
| P | 157.1 | 545.2 | 45.52 | 3.470 |
| Q | 152.3 | 534.8 | 63.36 | 3.511 |
| R | 152.7 | 602.9 | 74.30 | 3.948 |
| S | 150.7 | 504.7 | 66.88 | 3.349 |
| T | 156.5 | 579.1 | 66.80 | 3.700 |
| U | 156.5 | 505.8 | 24.03 | 3.232 |
| V | 153.0 | 611.6 | 69.14 | 3.997 |
| W | 152.2 | 712.0 | 55.99 | 4.678 |
| X | 153.8 | 578.2 | 54.68 | 3.759 |
| Y | 152.4 | 608.4 | 39.29 | 3.992 |
| Z | 152.1 | 580.5 | 76.02 | 3.816 |

EXPERIMENTAL TABLE 2
Experimental Physical Measurements for Sample Yarns

| | | Secant | | |
|---|---|---|---|---|
| | Stress at 5% | Modulus (gf/denier) | | |
| Sample | Elongation (psi) | 1% | 3% | 5% |
| A | 9.568 | 63.51 | 51.94 | 35.11 |
| B | 8.831 | 63.93 | 39.36 | 32.08 |
| C | 8.608 | 59.69 | 37.06 | 31.86 |
| D | 8.335 | 58.55 | 36.84 | 31.09 |
| E | 8.011 | 57.14 | 35.77 | 29.56 |
| F | 8.432 | 61.86 | 37.95 | 31.41 |
| G | 8.021 | 57.93 | 36.20 | 29.92 |
| H | 8.903 | 65.09 | 40.43 | 33.48 |
| I | 7.701 | 56.02 | 34.55 | 28.39 |
| J | 8.558 | 59.96 | 38.04 | 31.61 |
| K | 8.538 | 58.20 | 37.59 | 31.42 |
| L | 8.970 | 61.28 | 39.05 | 32.58 |
| M | 8.422 | 60.79 | 37.36 | 31.35 |
| N | 9.078 | 67.17 | 40.88 | 33.93 |
| O | 8.257 | 58.24 | 36.37 | 30.24 |
| P | 8.030 | 54.61 | 34.78 | 28.93 |
| Q | 8.202 | 58.64 | 37.36 | 30.54 |
| R | 8.679 | 61.91 | 38.67 | 32.23 |
| S | 7.778 | 57.98 | 35.81 | 29.27 |
| T | 8.423 | 61.35 | 37.19 | 30.52 |
| U | 8.031 | 57.26 | 35.22 | 29.10 |
| V | 8.797 | 63.88 | 39.48 | 32.60 |
| W | 9.784 | 63.78 | 42.70 | 36.45 |
| X | 8.747 | 59.99 | 38.57 | 32.25 |
| Y | 9.057 | 64.43 | 40.55 | 33.70 |
| Z | 8.433 | 60.14 | 37.99 | 31.44 |

EXPERIMENTAL TABLE 3
Shrinkage Data for Different Colored Polypropylene Yarns

| | Shrinkage Test and | |
|---|---|---|
| Sample Yarn | Temp. (° C.) | Shrinkage |
| A | 130 Hot air | 9.7% |
| R | 130 Hot air | 6.0% |
| T | 130 Hot air | 6.6% |
| U | 130 Hot air | 5.8% |
| Y | 130 Hot air | 8.0% |

Similarly, other inventive example yarns were made with varying extruder temperatures, draw roll 1 at 60° C., draw roll 2 at 90° C., draw rolls 3A and 3B at 130° C., and a final speed of 3500 m/min. The speeds of draw roll 2 and draw roll 1 were varied in order to give 60% +/−5% elongation at break, with a corresponding draw ratio the ratio of the final speed 3500 m/min to the speed of draw roll 1. The table below shows the extruder temperature, the color (with white indicating no color, and navy indicating the same blue pigment utilized above in Samples C-J), the nucleating additive, the level of the additive, and the draw ratio required to achieve 60% +/−5% elongation at break. Comparative fibers were also made and tested with no nucleating agent present.

| | | | Level | Draw |
|---|---|---|---|---|
| Temp (° C.) | Color | Additive | (ppm) | Ratio |
| 195 | white | p-MDBS | 2000 | 3.0 |
| 200 | white | p-MDBS | 2000 | 3.0 |
| 205 | white | p-MDBS | 2000 | 3.0 |
| 210 | white | p-MDBS | 2000 | 3.2 |
| 215 | white | p-MDBS | 2000 | 3.4 |
| 220 | white | p-MDBS | 2000 | 3.4 |
| 195 | navy | p-MDBS | 2000 | 3.0 |
| 200 | navy | p-MDBS | 2000 | 3.0 |
| 205 | navy | p-MDBS | 2000 | 3.0 |
| 210 | navy | p-MDBS | 2000 | 3.3 |
| 215 | navy | p-MDBS | 2000 | 3.4 |
| 220 | navy | p-MDBS | 2000 | 3.4 |
| 195 | white | DMDBS | 2000 | 2.6 |
| 200 | white | DMDBS | 2000 | 2.9 |
| 205 | white | DMDBS | 2000 | 3.1 |
| 210 | white | DMDBS | 2000 | 3.3 |
| 195 | navy | DMDBS | 2000 | 3.0 |
| 200 | navy | DMDBS | 2000 | 3.0 |
| 205 | navy | DMDBS | 2000 | 3.3 |
| 210 | navy | DMDBS | 2000 | 3.3 |
| 195 | white | none | 0 | 2.3 |
| 220 | white | none | 0 | 2.6 |
| 195 | navy | none | 0 | 3.2 |
| 220 | navy | none | 0 | 3.4 |

As can be seen from the data, the difference in draw ratio required for the inventive fibers of different colors is lower than that of the comparative fibers to make the same colors.

There are, of course, many alternative embodiments and modifications of the present invention which are intended to be included within the spirit and scope of the following claims.

What we claim is:

1. A colored polypropylene fiber, wherein said fiber is dimensionally stable and is made in accordance with substantially the same manufacturing procedures and parameters as a dimensionally stable non-colored polypropylene fiber having the same exact polypropylene composition but free from any coloring agent therein.

2. A method of producing such a colored fiber as above comprising the sequential steps of
a) providing a polypropylene composition comprising at least 200 ppm by weight of a nucleator compound and at least 200 ppm by weight of a coloring agent;
b) melting and mixing said polypropylene composition of step “a” to form a substantially homogeneous molten plastic formulation;
c) extruding said plastic formulation from step “b” to form a fiber structure; and
d) mechanically drawing said polypropylene fiber of step “c”.

3. A polypropylene yarn comprising at least one nucleating agent soluble therein and at least one coloring agent.

4. A polypropylene yarn according to claim 3 wherein the soluble nucleating agent is a dibenzylidene sorbitol compound.

5. A polypropylene yarn according to claim 4 wherein the soluble nucleating agent is MDBS.

6. A polypropylene yarn according to claim 4 wherein the soluble nucleating agent is DMDBS.

7. A polypropylene yarn according to claim 3 wherein said at least one coloring agent is at least one pigment.

8. A polypropylene yarn according to claim 4 wherein said at least one coloring agent is at least one pigment.

9. A polypropylene yarn according to claim 5 wherein said at least one coloring agent is at least one pigment.

10. A polypropylene yarn according to claim 6 wherein said at least one coloring agent is at least one pigment.

11. A textile product comprising at least one polypropylene yarn according to claim 1.

12. A textile product comprising at least one polypropylene yarn produced in accordance with the method of claim 2.

13. A textile product comprising at least one polypropylene yarn according to claim 3.

14. A textile product comprising at least one polypropylene yarn according to claim 4.

15. A textile product comprising at least one polypropylene yarn according to claim 5.

16. A textile product comprising at least one polypropylene yarn according to claim 6.

17. A textile product comprising at least one polypropylene yarn according to claim 7.

18. A textile product comprising at least one polypropylene yarn according to claim 8.

19. A textile product comprising at least one polypropylene yarn according to claim 9.

20. A textile product comprising at least one polypropylene yarn according to claim 1.
